(19) United States
(12) Patent Application Publication
(10) Pub. No.: US 2025/0212226 A1
(43) Pub. Date: Jun. 26, 2025

(54) TERMINAL, BASE STATION, AND WIRELESS COMMUNICATION METHOD

(71) Applicant: NTT DOCOMO, INC.,, Tokyo (JP)

(72) Inventors: Yuki Takahashi, Tokyo (JP); Satoshi Nagata, Tokyo (JP); Qiping Pi, Beijing (CN); Jing Wang, Beijing (CN); Lan Chen, Beijing (CN)

(73) Assignee: NTT DOCOMO, INC,, Tokyo (JP)

(21) Appl. No.: 18/846,488

(22) PCT Filed: Mar. 17, 2022
(86) PCT No.: PCT/JP2022/012449

§ 371 Date: Sep. 12, 2024

(51) Int. Cl. H04W 72/231; H04L 1/1812; H04L 5/00

(52) U.S. Cl. CPC H04W 72/231; H04L 1/1812; H04L 5/0053

(57) ABSTRACT

A terminal is disclosed including a receiving section that receives downlink control information that triggers retransmission of an acknowledgement codebook in a specific control resource set; and a control section that controls the retransmission of the acknowledgement codebook, wherein, when the acknowledgement feedback mode is set to separate, the control section determines the acknowledgement codebook to be retransmitted based on the control resource set in which the downlink control information was detected. In other aspects, a base station and a system are also disclosed.

### TECHNICAL FIELD

The present disclosure relates to a terminal, a base station, and a radio communication method.

### BACKGROUND ART

Long Term Evolution (LTE) has been specified to further achieve a higher data rate and lower latency in a Universal Mobile Telecommunications System (UMTS) network. Successor systems of LTE have also been studied to further achieve a broader band and higher speed from LTE. The successor systems of LTE include, for example, systems called LTE-advanced (LTE-A), future radio access (FRA), 5th generation mobile communication system (5G), 5G plus (5G+), radio access technology (New-RAT), new radio (NR), and the like.

In NR, for example, enhancement of a feedback function from a terminal to a base station has been discussed in order to improve a HARQ-ACK (Hybrid Automatic Repeat request-Acknowledgement) function (e.g., see Non-Patent Literature (hereinafter, referred to as “NPL”) 1 and NPL 2).

In 3GPP, it was also agreed to support reporting/feedback of HARQ-ACK by a Type 3 HARQ-ACK codebook (hereinafter, referred to as “HARQ-ACK CB”) as a function of retransmitting HARQ-ACK bits of all HARQ process IDs in Rel-16.

In addition, in 3GPP, it was agreed to support one-shot HARQ-ACK retransmission in Rel-17.

Furthermore, in 3GPP, a HARQ-ACK feedback mode in multi-TRP/panel transmission (also referred to as “multi-DCI based multi-TRP”), in which a plurality of Transmission/Reception Points (TRPs) cooperate with each other to perform MIMO transmission, was agreed in Rel-16. Note that, in the following description, the term “multi-DCI based multi-TRP” is sometimes simply abbreviated as “multi-TRP.”

### CITATION LIST

### Non-Patent Literature

NPL 1

“Enhanced Industrial Internet of Things (IoT) and ultra-reliable and low latency communication”, RP-201310, 3GPP TSG RAN Meeting #86e, 3GPP, July 2020

NPL 2

3GPP TS38.213 V17.0.0 (2021-12)

### SUMMARY OF INVENTION

In the one-shot HARQ-ACK retransmission agreed upon in Rel-17, multi-TRP is not considered. Therefore, there is room for study on retransmission of HARQ-ACK CB by one-shot HARQ-ACK retransmission in multi-TRP.

An aspect of the present disclosure is to provide a terminal, a base station, and a radio communication method each capable of appropriately performing HARQ-ACK CB retransmission in multi-TRP in consideration of a relation with one-shot HARQ-ACK retransmission.

### Solution to Problem

A terminal according to an embodiment of the present disclosure includes: a transmission section that transmits one or two uplink control signals including at least one of a first acknowledgement response to a first downlink signal transmitted from a first base station and/or a second acknowledgement response to a second downlink signal transmitted from a second base station; a reception section that receives one or two downlink control signals triggering retransmission of at least one of the first acknowledgement response and/or the second acknowledgement signal based on one-shot Hybrid Automatic Repeat request-Acknowledgement (HARQ-ACK) retransmission; and a control section that controls retransmission of the first acknowledgement response and the second acknowledgement signal in relation to a resource specified by the one or two downlink control signals.

A base station according to an embodiment of the present disclosure cooperates with another base station to communicate with a terminal, and includes: a reception section that receives, from the terminal, an uplink control signal including a first acknowledgement response to a first downlink signal transmitted from the base station and a second acknowledgment response to a second downlink signal transmitted from the another base station; and a transmission section that transmits a downlink control signal triggering retransmission of the first acknowledgement response and the second acknowledgement signal based on one-shot Hybrid Automatic Repeat request-Acknowledgement (HARQ-ACK).

In a radio communication system according to an embodiment of the present disclosure, a terminal transmits one or two uplink control signals including at least one of a first acknowledgement response to a first downlink signal transmitted from a first base station and/or a second acknowledgement response to a second downlink signal transmitted from a second base station, receives one or two downlink control signals triggering retransmission of at least one of the first acknowledgement response and/or the second acknowledgement signal based on one-shot Hybrid Automatic Repeat request-Acknowledgement (HARQ-ACK) retransmission, and controls retransmission of the first acknowledgement response and the second acknowledgement signal in relation to a resource specified by the one or two downlink control signal

### BRIEF DESCRIPTION OF DRAWINGS

FIG. 1 is a diagram for describing a radio communication system in an embodiment;

FIG. 2 illustrates an exemplary configuration of a radio communication system when dual connectivity (DC) is performed;

FIG. 3 is a diagram for describing an overview of Type 1 HARQ-ACK CB;

FIG. 4 is a diagram for describing an overview of Type 2 HARQ-ACK CB;

FIG. 5 is a diagram for describing an overview of Type 3 HARQ-ACK CB;

FIG. 6 is a diagram for describing retransmission of HARQ-ACK CB by one-shot HARQ-ACK retransmission;

FIG. 7 is another diagram for describing retransmission of HARQ-ACK CB by one-shot HARQ-ACK retransmission;

FIG. 8 is a diagram for describing retransmission of HARQ-ACK CB by one-shot HARQ-ACK retransmission in multi-DCI based multi-TRP in which Joint feedback is configured;

FIG. 9 is a diagram for describing retransmission of HARQ-ACK CB by one-shot HARQ-ACK retransmission in multi-DCI based multi-TRP in which Separate feedback is configured;

FIG. 10 is a block diagram illustrating an exemplary configuration of a base station according to the present embodiment;

FIG. 11 is a block diagram illustrating an exemplary configuration of a terminal according to the present embodiment;

FIG. 12 illustrates an exemplary hardware configuration of the base station and the terminal according to the present embodiment; and

FIG. 13 illustrates an exemplary configuration of a vehicle according to an embodiment of the present invention.

### Description of Embodiments

### Embodiment

Hereinafter, an embodiment according to an aspect of the present disclosure will be described in detail with reference to the accompanying drawings.

### System Configuration

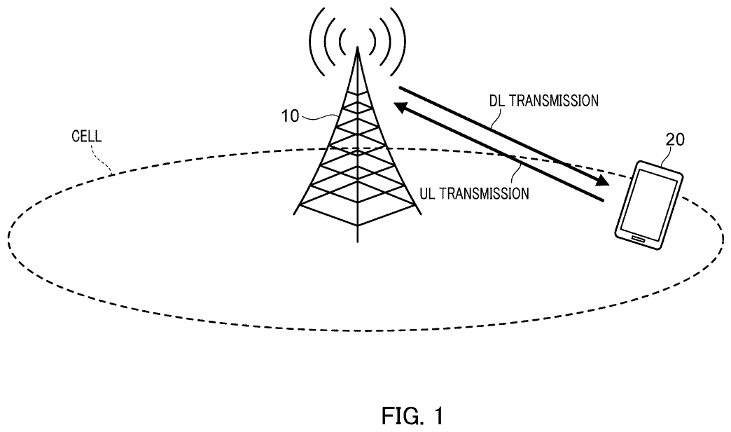

FIG. 1 is a diagram for describing a radio communication system in an embodiment of the present disclosure. As illustrated in FIG. 1, the radio communication system in the embodiment of the present invention includes base station 10 and terminal 20. FIG. 1 illustrates one base station 10 and one terminal 20, but it is merely an example, and the numbers of base stations 10 and terminals 20 may each be plural.

Base station 10 is a communication apparatus that provides one or more cells and performs radio communication with terminal 20. A physical resource for a radio signal is defined in time domain and frequency domain, in which the time domain may be defined by the number of OFDM symbols and the frequency domain may be defined by the number of subcarriers or the number of resource blocks. Further, a transmission time interval (TTI) in the time domain may be a slot or may be a subframe.

Base station 10 can perform carrier aggregation in which communication with terminal 20 is performed by bundling together a plurality of cells (e.g., a plurality of component carriers (CCs)). In the carrier aggregation, one primary cell (PCell) and one or more secondary cells (SCells) are used.

Base station 10 transmits a synchronization signal, system information, and the like to terminal 20. The synchronization signal is, for example, NR-PSS and NR-SSS. The system information is transmitted through, for example, NR-PBCH or PDSCH, and is also referred to as broadcast information. As illustrated in FIG. 1, base station 10 transmits a control signal or data to terminal 20 in Downlink (DL) and receives a control signal or data from terminal 20 in Uplink (UL). Note that what is transmitted by a control channel such as a Physical Uplink Control Channel (PUCCH) or Physical Downlink Control Channel (PDCCH) is referred to as a control signal and what is transmitted by a shared channel such as a Physical Uplink Shared Channel (PUSCH) or Physical Downlink Shared Channel (PDSCH) is referred to as data, but these names are merely examples.

Terminal 20 is a communication device having a radio communication function, such as a smart phone, a mobile phone, a tablet, a wearable terminal, or a Machine-to-Machine (M2M) communication module. As illustrated in FIG. 1, terminal 20 receives a control signal or data from base station 10 in DL and transmits a control signal or data to base station 10 in UL, so that terminal 20 uses various communication services provided by the radio communication system. Note that terminal 20 may be referred to as UE (User Equipment) and base station 10 may be referred to as gNB.

Terminal 20 can perform carrier aggregation in which communication with base station 10 is performed by bundling together a plurality of cells (a plurality of component carriers (CCs)). In the carrier aggregation, one PCell and one or more SCells are used. A PUCCH-SCell having PUCCH may also be used.

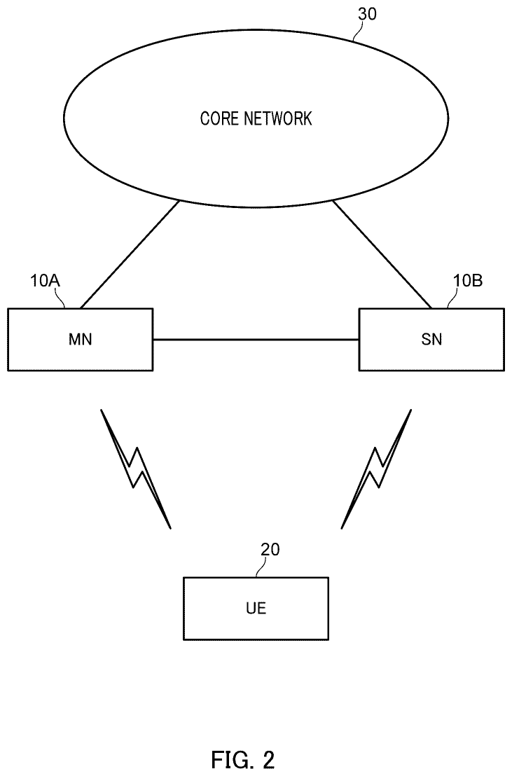

FIG. 2 illustrates an exemplary configuration of the radio communication system when dual connectivity (DC) is performed. As illustrated in FIG. 2, base station 10A, which serves as a master node (MN), and base station 10B, which serves as a secondary node (SN), are included. Base station 10A and base station 10B are each connected to a core network. Terminal 20 can communicate with both base station 10A and base station 10B.

A cell group provided by base station 10A, which serves as MN, is referred to as a master cell group (MGC), and a cell group provided by base station 10B, which serves as SN, is referred to as a secondary cell group (SCG). In DC, the MCG is composed of one PCell and one or more SCells, and the SCG is composed of one primary-SCell (PSCell) and one or more SCells.

The processing operation in the present embodiment may be executed in the system configuration illustrated in FIG. 2 or in a system configuration other than the system configuration described above.

### <HARQ-ACK CB>

In 3GPP, functional enhancement of HARQ-ACK feedback by HARQ-ACK CB has been studied in terms of extension of URLLC technology. The HARQ-ACK is exemplary information on an acknowledgement response (e.g., acknowledgement) to data received by the terminal. The HARQ-ACK CB includes a plurality of HARQ-ACK bits and is transmitted in one PUCCH resource.

In 3GPP, HARQ-ACK CBs of Type 1 and Type 2 (hereinafter, sometimes abbreviated as “Type 1/2”) has been specified in Rel-15. Further, it was agreed to support reporting/feedback of HARQ-ACK by Type 3 HARQ-ACK codebook as a function of retransmitting HARQ-ACK bits of all HARQ process IDs in Rel-16. Furthermore, in 3GPP, e-Type 3 HARQ-ACK CB, which is an enhanced Type 3 HARQ-ACK CB, has been specified in Rel-17. Terminal 20 may be indicated which type of HARQ-ACK CB to be applied, for example, by a higher layer parameter such as pdsch-HARQ-ACK-Codebook by higher layer signaling such as Radio Resource Control (RRC). Each type of HARQ-ACK CB is briefly described below.

### Type 1 HARQ-ACK CB

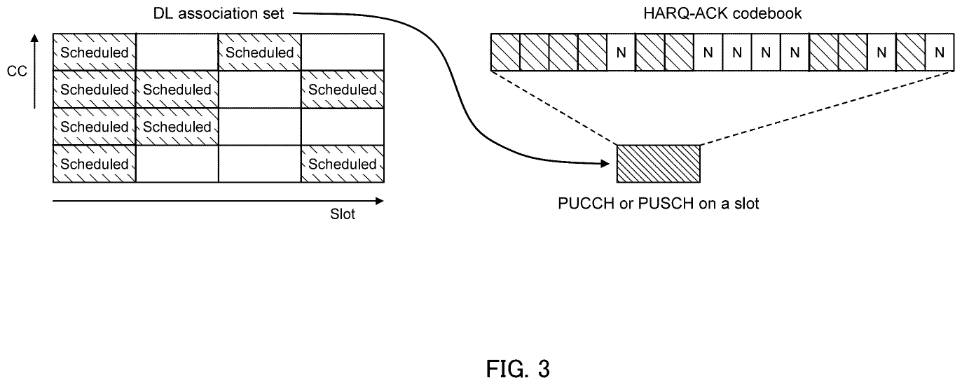

FIG. 3 is a diagram for describing an overview of Type 1 HARQ-ACK CB. The term “Scheduled” illustrated in FIG. 3 indicates a slot scheduled by DCI, for example. The term CC indicates a component carrier.

In the Type 1 HARQ-ACK CB, terminal 20 generates a HARQ-ACK bit for PDSCH regardless of whether a scheduled slot (PDSCH) is present. For example, the terminal may configure NACK on unscheduled PDSCHs as illustrated in the “HARQ-ACK codebook” of FIG. 3.

### Type 2 HARQ-ACK CB

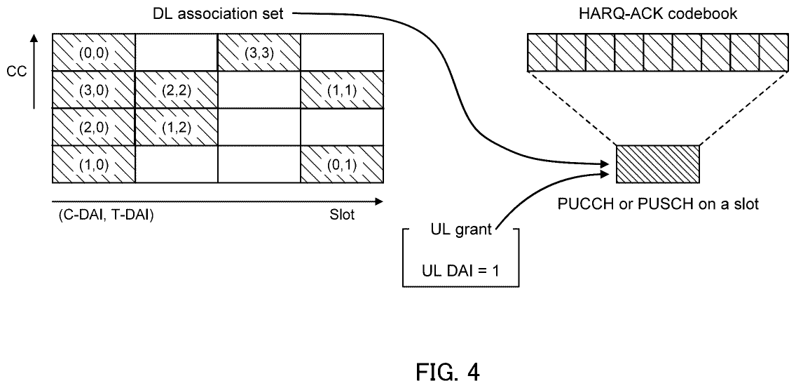

FIG. 4 is a diagram for describing an overview of Type 2 HARQ-ACK CB, and (x, y) illustrated in FIG. 4 indicates a slot scheduled by DCI, for example. In FIG. 4, x corresponds to a C-DAI value and y corresponds to a T-DAI value. DAI is an abbreviation for a downlink assignment index. DAI indicates, for example, allocation of scheduled PDSCH where HARQ-ACK is bundled into HARQ-ACK CB.

In the Type 2 HARQ-ACK CB, terminal 20 generates a HARQ-ACK bit for the scheduled PDSCH. For example, terminal 20 may configure HARQ-ACK on the scheduled PDSCH as illustrated in the “HARQ-ACK codebook” of FIG. 4.

Note that the C-DAI is counted up from 1. In a case of a 2-bit field, for example, the C-DAI is repeated as 1->2->3->0->. . . The C-DAI is counted up for DCI reception opportunity of each CC for each slot, and is counted up from the last value of the previous slot even when the slot changes. The T-DAI indicates the last value of the C-DAI in each slot.

### Type 3 HARQ-ACK CB

In 3GPP, it was agreed to support Type 3 HARQ-ACK CB as a function of retransmitting HARQ-ACK bits of all HARQ-process IDs in Rel-16. Further, the following points were agreed for the Type 3 HARQ-ACK CB in 3GPP.

Terminal 20 determines the Type-3 HARQ-ACK CB when “pdsch-HARQ-ACK-OneShotFeedback-r16” is provided. Terminal 20 multiplexes only the Type 3 HARQ-ACK CB in PUCCH or PUSCH for transmission in a slot.

When detecting a DCI format including a one-shot HARQ-ACK request field of value 1, terminal 20 determines PUCCH or PUSCH for multiplexing Type 3 HARQ-ACK CB. The type 3 HARQ-ACK CB includes HARQ-ACK information of all configured HARQ processes of all configured serving cells. Terminal 20 assumes providing HARQ-ACK information in response to a request of the Type 3 HARQ-ACK CB, N symbols after the last symbol of PDCCH providing a DCI format.

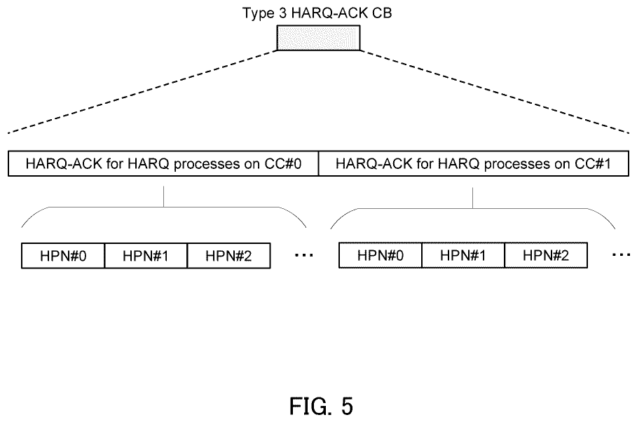

FIG. 5 is a diagram for describing an overview of Type 3 HARQ-ACK CB. As illustrated in FIG. 5, in the Type 3 HARQ-ACK CB, HARQ-ACKs are first arranged in ascending order of HARQ process number (HPN) for each HARQ-ACK for a HARQ process on each CC. Then, HARQ-ACKs for HARQ processes on the respective CCs are arranged in ascending order of CC number.

### E-Type 3 HARQ-ACK CB

In 3GPP, the following points were agreed on e-Type 3 HARQ-ACK CB in Rel-17.

The size of e-Type 3 HARQ-ACK CB is smaller than the size of Type 3 HARQ-ACK CB specified in Rel-16. The size of e-Type 3 HARQ-ACK CB is specified by a configuration of RRC.

The e-Type 3 HARQ-ACK CB is triggered by DCI 1_1 and DCI 1_2. Hereinafter, DCI for triggering e-Type 3 HARQ-ACK CB is sometimes referred to as “e-Type 3 HARQ-ACK CB triggering DCI” or “triggering DCI.”

In the e-Type 3 HARQ-ACK CB, one or more small CBs are configured by RRC. The triggering DCI indicates the configured small CB(s). The configured small CBs may each include a HARQ process for a subset of configured CCs or a subset of configured HARQ processes (specific to CC). Terminal 20 can transmit some subsets included in the e-Type 3 HARQ-ACK CB.

The e-Type 3 HARQ-ACK CB is constructed regardless of PHY priority. The triggering DCI indicates the PHY priority of PUCCH transmitting the e-Type 3 HARQ-ACK CB.

When terminal 20 cannot map a HARQ process to an e-Type 3 HARQ-ACK CB, terminal 20 does not assume that a Type 1/2 HARQ-ACK CB is transmitted in the same slot as the e-Type 3 HARQ-ACK CB.

Note that an enhanced Type 3 HARQ-ACK codebook is referred to as “e-Type 3 HARQ-ACK CB” below. In addition, the Type 3 HARQ-ACK CB other than the e-Type 3 HARQ-ACK CB, that is, legacy Type 3 HARQ-ACK CB specified in Rel-16 is simply referred to as “Type 3 HARQ-ACK CB.” Further, the Type 3 HARQ-ACK CB and the e-Type 3 HARQ-ACK CB are collectively referred to as “(e)Type 3 HARQ-ACK CB.”

### <One-Shot HARQ-ACK Retransmission>

In 3GPP, it was agreed to support one-shot HARQ-ACK retransmission by DL grant DCI in Rel-17.

DCI for triggering one-shot HARQ-ACK retransmission (hereinafter, referred to as “one-shot DCI”) can trigger a retransmission of only one HARQ-ACK CB. Terminal 20 does not assume a plurality of pieces of one-shot DCI indicating the same slot. That is, in one slot, only one HARQ-ACK CB/PUCCH occasion may be retransmitted. Note that the type of HARQ-ACK CB for which retransmission is triggered by one-shot DCI may be any of Type 1, Type 2, Type 3, and e-Type 3. Note that one-shot DCI may mean DCI including a HARQ-ACK retransmission indicator field.

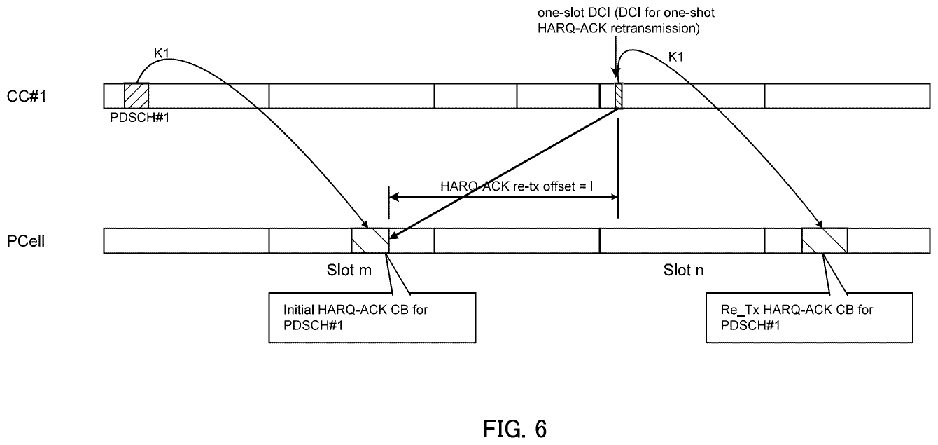

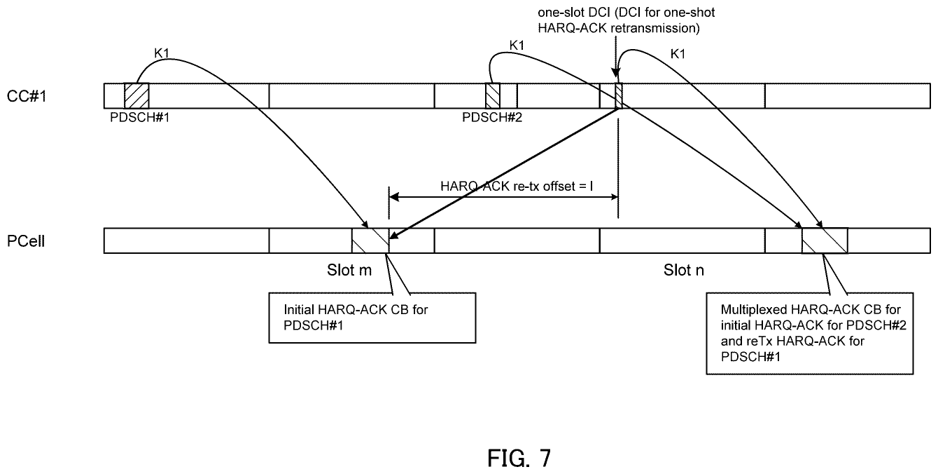

FIGS. 6 and 7 are diagrams for describing retransmission of HARQ-ACK CB by one-shot HARQ-ACK retransmission. The horizontal axis in FIGS. 6 and 7 represents a time axis. In the examples of FIGS. 6 and 7, base station 10 transmits a signal in component carrier CC #1 of the reference cell, and terminal 20 transmits a signal in PCell. Note that, in the following description, a plurality of slots may be referred to as the first slot, the second slot, and so forth, in order from the oldest slot in time (from the left side of the drawing).

Upon receiving PDSCH #1 from base station 10, terminal 20 transmits a HARQ-ACK CB corresponding to PDSCH #1 on a PUCCH in slot m (second slot in FIGS. 6 and 7) after the elapse of K1 value (K1=1 in FIGS. 6 and 7) from the PDSCH #1 reception slot. Note that the K1 value may be a parameter indicating the number of slots from a slot in which data is scheduled on a PDSCH to a slot in which feedback information (e.g., HARQ-ACK) for the PDSCH is transmitted. Further, the K1 value may be referred to as a slot offset value or the like. The K1 value may be specified by the specifications, or may be indicated to terminal 20 by higher layer signaling such as RRC.

When base station 10 cannot demodulate the HARQ-ACK CB or the like, base station 10 transmits one-shot DCI on a PDCCH in slot n (fourth slot in FIGS. 6 and 7).

Upon receiving the one-shot DCI, terminal 20 retransmits the HARQ-ACK CB to base station 10 on a PUCCH in slot n+K1 (fifth slot in FIGS. 6 and 7) after the elapse of K1 value from one-shot DCI reception slot n. Note that, upon receiving the one-shot DCI, terminal 20 identifies slot m in which the first HARQ-ACK CB is transmitted, by m=n−l. The letter “.” is a parameter value (HARQ_retx_offset) indicating a retransmission offset of HARQ-ACK provided by one-shot DCI.

Note that, as illustrated in FIG. 7, terminal 20 can multiplex a HARQ-ACK CB for retransmission (hereinafter, referred to as “retransmission HARQ-ACK CB”) by one-shot DCI and another first-time HARQ-ACK bit having the same PHY priority in a PUCCH transmission in slot n+K1.

### <HARQ-ACK Feedback in Multi-TRP>

In 3GPP, a HARQ-ACK feedback mode in multi-TRP/panel transmission (multi-DCI based multi-TRP) was agreed to improve transmission reliability and throughput in Rel-16.

In this case, the first TRP transmits, to UE, DCI indicating the scheduled first PDSCH using the first PDCCH in the first CORESET (Control Resource Set) and a data signal using the first PDSCH. The second TRP transmits, to UE, DCI indicating the scheduled second PDSCH using the second PDCCH in the second CORESET and a data signal using the second PDSCH. The UE monitors the first/second PDCCHs in the first/second CORESETs to receive DCI and monitors the first/second PDSCHs based on the DCI. The UE then performs feedback transmission of HARQ-ACKs corresponding to the respective PDSCHs to TRPs using a PUCCH resource (or PUSCH resource).

Note that the DCI indicating PDSCH may include a field of PUCCH Resource Indicator (PRI). The PRI corresponds to the information that specifies a resource for transmitting HARQ-ACK corresponding to the PDSCH, and may be referred to as an ACK/NACK Resource Indicator (ARI). UE may determine a resource for transmitting HARQ-ACK based on the PRI.

For feedback transmission, two options of Joint feedback and Separate feedback are defined. These options are semi-statically configured by RRC. UE determines which of the two options is configured, by a higher layer parameter such as ackNackFeedbackMode indicated by RRC.

### Joint Feedback

In Joint feedback, UE multiplexes a plurality of HARQ-ACKs corresponding to respective PDSCHs, and transmits the HARQ-ACKs to one TRP on one PUCCH. In the Joint feedback, HARQ-ACKs can be transmitted on one PUCCH resource, so that resource overhead can be reduced.

However, in the Joint feedback, it is necessary to carry HARQ-ACK for another TRP (TRP-2) received by one TRP (TRP-1) in the backhaul link from TRP-1 to TRP-2. This may result in performance loss due to HARQ-ACK delay in the backhaul.

### Separate Feedback

In Separate feedback, UE transmits a plurality of HARQ-ACKs corresponding to respective PDSCHs to respective TRPs on different PUCCHs. The Separate feedback, which is an independent operation for each TRP, is a simple scheme compared to Joint feedback, and the HARQ-ACK delay does not increase even when the backhaul delay between TRPs is large.

However, the Separate feedback has a problem in a method of allocating transmission power of PUCCHs, and thus a collision resolution mechanism for solving duplicate transmission in uplink is required.

### <Considerations>

As described above, in 3GPP, it was agreed to support one-shot HARQ-ACK retransmission. However, multi-TRP is not considered in the one-shot HARQ-ACK retransmission agreed upon in Rel-17. Therefore, there is room for study on retransmission of a HARQ-ACK CB by one-shot HARQ-ACK retransmission in multi-TRP.

For the above consideration, the following three proposals are presented in the present embodiment, and cases, options (sometimes abbreviated as “Opt.”), variations, and/or alternations (sometimes abbreviated as “Alt.”) of each proposal will be described. Further, specific examples of each option will be described.

### Proposal 1

In Proposal 1, a relation between multi-DCI based multi-TRP and one-shot HARQ-ACK retransmission is described.

### Option 1

Option 1 does not support a joint operation of multi-DCI based multi-TRP and one-shot HARQ-ACK retransmission. In this case, each base station 10 of multi-DCI based multi-TRP indicates to terminal 20 retransmission of HARQ-ACK by DCI that does not include a HARQ-ACK retransmission indicator field, not by one-shot DCI.

Specific examples of the assumption of terminal 20 in Option 1 are described below.

### Example 1

Terminal 20 does not assume that the trigger of one-shot HARQ-ACK retransmission is enabled for a PUCCH cell group and that any CORESET on any/active DownLink BandWidth Part (DL BWP) of at least one cell of the PUCCH cell group is configured with a higher layer parameter such as coresetPoolIndex. Note that coresetPoolIndex is a higher parameter indicating CORESET by value 0/1, and may be indicated to terminal 20 by higher layer signaling such as RRC.

### Example 2

Terminal 20 does not assume that the trigger of one-shot HARQ-ACK retransmission is enabled for a PUCCH cell group and that a first CORESET and a second CORESET are present on any/active DL BWP of a cell of the PUCCH cell group. Here, the first CORESET is a CORESET to which no coresetPoolIndex is provided or coresetPoolIndex with value 0 is provided, and the second CORESET is a CORESET to which coresetPoolIndex with value 1 is provided.

### Example 3

Terminal 20 does not assume that DCI detected in CORESET configured with coresetPoolIndex (value 1/0) is one-shot DCI.

### Example 4

Terminal 20 does not assume, in the case of a DCI format that is enabled as one-shot HARQ-ACK retransmission in a PUCCH cell group, to monitor the DCI format of the CORESET configured with coresetPoolIndex (value 1/0).

### Effect

According to Option 1 of Proposal 1, each base station 10 of multi-DCI based multi-TRP does not need to transmit one-shot DCI, thereby simplifying the operation (control).

### Option 2

Option 2 supports a joint operation of multi-DCI based multi-TRP and one-shot HARQ-ACK retransmission. Hereinafter, Option 2 is described separately for a case in which Joint feedback is configured (ackNackFeedbackMode 32 joint) (Case A) and a case in which Separate feedback is configured (ackNackFeedbackMode=separate) (Case B) in the multi-DCI based multi-TRP operation.

### Case A of Option 2

Case A of Option 2 (Option 2A) is described below.

### Option 2A-1

Option 2A-1 supports a joint operation of multi-DCI based multi-TRP in which Joint feedback is configured and one-shot HARQ-ACK retransmission.

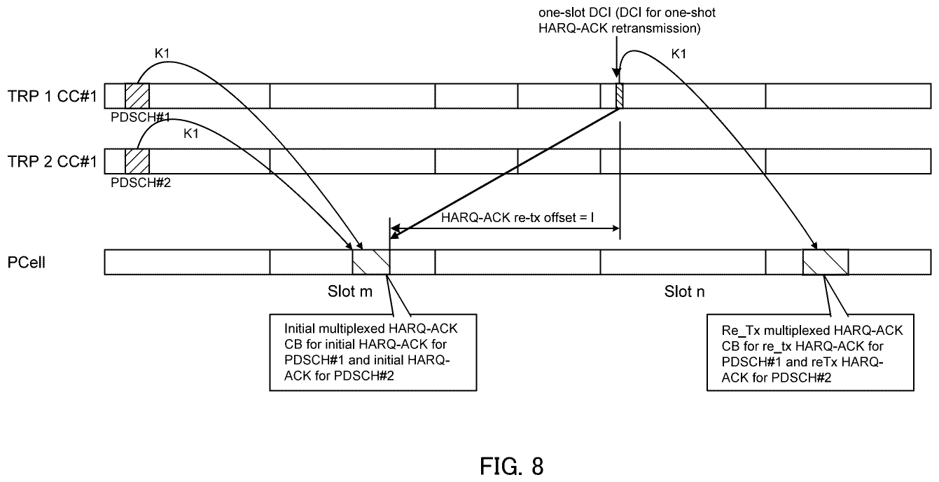

FIG. 8 is a diagram for describing retransmission of HARQ-ACK CB by one-shot HARQ-ACK retransmission in multi-DCI based multi-TRP in which Joint feedback is configured. The horizontal axis in FIG. 8 represents a time axis. In the example of FIG. 8, two base stations 10 (TRP 1 and TRP 2) both transmit a signal in component carrier CC #1 of the reference cell, and terminal 20 transmits a signal in PCell.

Upon receiving PDSCH #1 from one base stations 10 (TRP 1), and at the same time, receiving PDSCH #2 from the other base station 10 (TRP 2), terminal 20 transmits, to the one base station 10 (TRP 1), a HARQ-ACK CB obtained by multiplexing a HARC-ACK bit corresponding to PDSCH #1 and a HARQ-ACK bit corresponding to PDSCH #2 on a PUCCH in slot m (second slot in FIG. 8) after the elapse of K1 value (K1=1 in FIG. 8) from the slot in which PDSCH #1 and PDSCH #2 are received.

When base station 10 (TRP 1) cannot demodulate the HARQ-ACK CB or the like, base station 10 (TRP 1) transmits one-shot DCI on a PDCCH in slot n (fourth slot in FIG. 8).

Terminal 20 monitors the CORESET to which the one-shot DCI belongs, and detects the one-shot DCI. Note that a method for determining the CORESET of the retransmission HARQ-ACK CB in this case will be described later.

Upon receiving one-shot DCI, terminal 20 retransmits a HARQ-ACK CB having a PHY priority indicated by the one-shot DCI to the one base stations 10 (TRP 1) on a PUCCH in slot n+K1 (fifth slot in FIG. 8) after the elapse of K1 value from slot n in which the one-shot DCI is received. Note that, when no field having a PHY priority is present in the one-shot DCI, the priority is regarded as “0.” Upon receiving the one-shot DCI, terminal 20 identifies slot m in which the first HARQ-ACK CB is transmitted, by m=n−l.

### Effect

According to Optional 2A-1 of Proposal 1, base station 10 of multi-DCI based multi- TRP can indicate retransmission of HARQ-ACK CB by one-shot DCI when Joint feedback is configured.

### Option 2A-2

Option 2A-2 does not support a joint operation of multi-DCI based multi-TRP in which Joint feedback is configured and one-shot HARQ-ACK retransmission. In this case, each base station 10 of multi-DCI based multi-TRP indicates to terminal 20 retransmission of HARQ-ACK by normal DCI, not by one-shot DCI, when Joint feedback is configured.

Specific examples of the assumption of terminal 20 in Option 2A-2 are described below.

### Example 1

Terminal 20 does not assume that, when Joint feedback is configured, the trigger of one-shot HARQ-ACK retransmission is enabled for a PUCCH cell group, and any CORESET on any/active DL BWP of at least one cell of the PUCCH cell group is configured with coresetPoolIndex (value 1/0).

### Example 2

Terminal 20 does not assume that, when Joint feedback is configured, the trigger of one-shot HARQ-ACK retransmission is enabled for a PUCCH cell group, and a first CORESET and a second CORESET are present on any/active DL BWP on a cell of the PUCCH cell group. Here, the first CORESET is a CORESET to which no coresetPoolIndex is provided or coresetPoolIndex with value 0 is provided, and the second CORESET is a CORESET to which coresetPoolIndex with value 1 is provided.

### Example 3

Terminal 20 does not assume that, when Joint feedback is configured, DCI detected in the CORESET configured with coresetPoolIndex (value 1/0) is one-shot DCI.

### Example 4

Terminal 20 does not assume, when Joint feedback is configured, to monitor a DCI format of the CORESET configured with coresetPoolIndex (value 1/0) in the case of a DCI format that is enabled as a trigger of one-shot HARQ-ACK retransmission in a PUCCH cell group.

### Effect

According to Option 2A-2 of Proposal 1, each base station 10 of multi-DCI based multi-TRP does not need to transmit one-shot DCI when Joint feedback is configured, thereby simplifying the operation (control).

### Case B of Option 2

Case B of Option 2 (Option 2B) is described below.

### Option 2B-1

Option 2B-1 supports a joint operation of multi-DCI based multi-TRP in which Separate feedback is configured and one-shot HARQ-ACK retransmission.

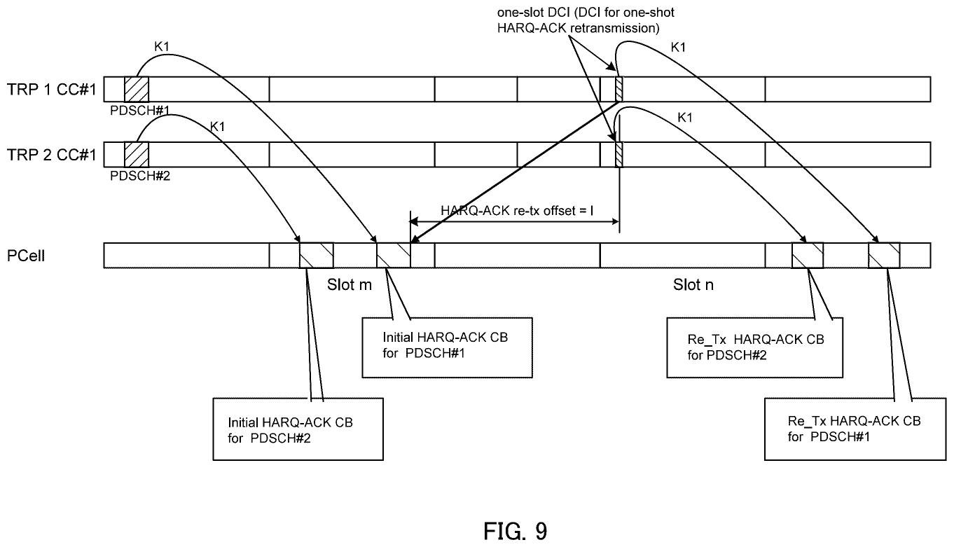

FIG. 9 is a diagram for describing retransmission of HARQ-ACK CB by one-shot HARQ-ACK retransmission in multi-DCI based multi-TRP in which Separate feedback is configured. The horizontal axis in FIG. 9 represents a time axis. In the example of FIG. 9, two base stations 10 (TRP 1 and TRP 2) both transmit a signal in component carrier CC #1 of the reference cell, and terminal 20 transmits signals in PCell.

Upon receiving PDSCH #1 from one base station 10 (TRP 1), and at the same time, receiving PDSCH #2 from the other base station 10 (TRP 2), terminal 20 transmits a HARQ-ACK CB corresponding to PDSCH #1 to the one base station 10 (TRP 1) and a HARQ-ACK CB corresponding to PDSCH #2 to the other base station 10 (TRP 2) on PUCCHs in slot m (second slot in FIG. 9) after the elapse of K1 value (K1=1 in FIG. 9) from the slot in which PDSCH #1 and PDSCH #2 are received. At this time, the PUCCH resource including HARQ-ACK CB corresponding PDSCH #1 and the PUCCH resource including HARQ-ACK CB corresponding PDSCH #2 may be time-multiplexed.

When the one base station 10 (TRP 1) cannot demodulate the HARQ-ACK CB, the one base station 10 (TRP 1) transmits one-shot DCI on a PDCCH in slot n (fourth slot in FIG. 9). Similarly, when the another base station 10 (TRP 2) cannot demodulate HARQ-ACK CB, the another base station 10 (TRP 2) transmits one-shot DCI on a PDCCH in slot n.

Terminal 20 monitors the CORESETs to which the one-shot DCI belongs, and detects the one-shot DCI. Note that a method for determining the CORESETs of the retransmission HARQ-ACK CB in this case will be described later.

Upon receiving one-shot DCI from the one base stations 10 (TRP 1), terminal 20 retransmits a HARQ-ACK CB having a PHY priority indicated by the one-shot DCI to the one base stations 10 (TRP 1) on a PUCCH in slot n+K1 after the elapse of K1 value from slot n in which the one-shot DCI is received. Similarly, upon receiving one-shot DCI from the other base station 10 (TRP 2), terminal 20 retransmits a HARQ-ACK CB having a PHY priority indicated by the one-shot DCI to the other base station 10 (TRP 2) on a PUCCH in slot n+K1 (fifth slot in FIGS. 6 and 7) after the elapse of K1 value from slot n in which the one-shot DCI is received. At this time, the PUCCH resource including the retransmission HARQ-ACK CB corresponding PDSCH #1 and the PUCCH resource including the retransmission HARQ-ACK CB corresponding PDSCH #2 may be time-multiplexed. Note that, when no field having a PHY priority is present in the one-shot DCI, the priority is regarded as “0.” Upon receiving the one-shot DCI, terminal 20 identifies slot m in which the first HARQ-ACK CB is transmitted, by m=n−l.

### Effect

According to Optional 2B-1 of Proposal 1, base station 10 of multi-DCI based multi-TRP can indicate retransmission of HARQ-ACK CB by one-shot DCI when Separate feedback is configured.

### Option 2B-2

Option 2B-2 does not support a joint operation of multi-DCI based multi-TRP in which Separate feedback is configured and one-shot HARQ-ACK retransmission. In this case, when Separate feedback is configured, each base station 10 of multi-DCI based multi-TRP indicates to terminal 20 retransmission of HARQ-ACK by normal DCI, not by one-shot DCI.

Specific examples of the assumption of terminal 20 in Option 2B-2 are described below.

### Example 1

Terminal 20 does not assume that, when Separate feedback is configured, the trigger of one-shot HARQ-ACK retransmission is enabled for a PUCCH cell group, and any CORESET on any/active DL BWP of at least one cell of the PUCCH cell group is configured with coresetPoolIndex (value 1/0).

### Example 2

Terminal 20 does not assume that, when Separate feedback is configured, the trigger of one-shot HARQ-ACK retransmission is enabled for a PUCCH cell group, and a first CORESET and a second CORESET are present on any/active DL BWP on a cell of the PUCCH cell group. Here, the first CORESET is a CORESET to which no coresetPoolIndex is provided or coresetPoolIndex with value 0 is provided, and the second CORESET is a CORESET to which coresetPoolIndex with value 1 is provided.

### Example 3

Terminal 20 does not assume that, when Separate feedback is configured, DCI detected in the CORESET configured with coresetPoolIndex (value 1/0) is one-shot DCI.

### Example 4

Terminal 20 does not assume, when Separate feedback is configured, to monitor a DCI format of the CORESET configured with coresetPoolIndex (value 1/0) in the case of a DCI format that is enabled as a trigger of one-shot HARQ-ACK retransmission in a PUCCH cell group.

### Effect

According to Option 2B-2 of Proposal 1, each base station 10 of multi-DCI based multi-TRP does not need to transmit one-shot DCI when Separate feedback is configured, thereby simplifying the operation (control).

### Variation

In Proposal 1, supporting/not supporting of a joint operation of multi-DCI based multi-TRP and one-shot HARQ-ACK retransmission may be switched depending on the Type of HARQ-ACK CB. For example, the joint operation of multi-DCI based multi-TRP and one-shot HARQ-ACK retransmission need not be supported when the type of HARQ-ACK CB is Type 1/2 and may be supported when the type of HARQ-ACK CB is (e)Type 3.

### Proposal 2

In Proposal 2, a specific method for determining a HARQ-ACK CB to be retransmitted when terminal 20 detects one-shot DCI in the above-described Options 2A-1 and 2B-1 of Proposal 1 in the multi-DCI based multi-TRP operation will be described.

### Option 1

In Option 1, a HARQ-ACK CB to be retransmitted is determined based on the CORESET to which one-shot DCI belongs.

When detecting one-shot DCI in the first CORESET, terminal 20 retransmits a HARQ-ACK CB that is transmitted in slot m for the first CORESET. Similarly, when detecting one-shot DCI in the second CORESET, terminal 20 retransmits a HARQ-ACK CB that is transmitted in slot m for the second CORESET.

Note that, in the case that terminal 20 has not generated, in slot m, a HARQ-ACK CB having a PHY priority indicated by the one-shot DCI in the CORESET to which the one-shot DCI belongs, terminal 20 does not transmit a HARQ-ACK CB on a PUCCH resource indicated by the one-shot DCI for HARQ-ACK CB retransmission (hereinafter, referred to as “retransmission PUCCH resource”) and ignores the one-shot DCI.

### Option 2

In Option 2, a HARQ-ACK CB to be retransmitted is determined regardless of the CORESET to which one-shot DCI belongs. As specific examples of Option 2, the following two sub-options are considered.

### Option 2-1

As Option 2-1, terminal 20 may fixedly retransmit a HARQ-ACK CB that is transmitted in slot m for either the preconfigured first CORESET or second CORESET. Note that, in this case, the CORESET for which the HARQ-ACK CB is retransmitted may be determined by the specifications, or indicated to terminal 20 by higher layer signaling such as RRC.

Note that, in the case that terminal 20 has not generated, in slot m, a HARQ-ACK CB having a PHY priority indicated by the one-shot DCI for the preconfigured CORESETs, terminal 20 does not transmit a HARQ-ACK CB on a retransmission PUCCH resource and ignores the one-shot DCI.

### Option 2-2

As Option 2-2, terminal 20 may always retransmit HARQ-ACK CBs that are transmitted in slot m for both the first CORESET and second CORESET.

Note that, when Separate feedback is configured, terminal 20 may connect a HARQ-ACK CB for the first CORESET and a HARQ-ACK CB for the second CORESET to each other.

Note that, in the case that terminal 20 has not generated, in slot m, a HARQ-ACK CB having a PHY priority indicated by the one-shot DCI for either the first CORESET or the second CORESET, terminal 20 does not transmit a HARQ-ACK CB on a retransmission PUCCH resource and ignores the one-shot DCI.

### Variation

In Proposal 2, different options may be applied between the case in which Joint feedback is configured and the case in which Separate feedback is configured. For example, Option 1 or 2-1 may be applied when Separate feedback is configured, and Option 2-2 may be applied when Joint feedback is configured.

### Proposal 3

In Proposal 3, a possibility/method of multiplexing a HARQ-ACK bit of retransmission HARQ-ACK CB by one-shot DCI (hereinafter, referred to as “first HARQ-ACK bit”) and another HARQ-ACK bit having the same PHY priority as the first HARQ-ACK bit (hereinafter, referred to as “second HARQ-ACK bit”) in the multi-DCI based multi-TRP operation is described.

### Alternation A

Alt. A is a case in which Separate feedback is configured and the above-described Option 1 or 2-1 of Proposal 2 is applied, that is, a HARQ-ACK CB is retransmitted by one-shot DCI for either the first CORESET or second CORESET. In the following description, the CORESET for which the retransmission HARQ-ACK CB is transmitted is referred to as “retransmission CORESET” and the CORESET for which the retransmission HARQ-ACK CB is not transmitted is referred to as “non-retransmission CORESET.”

Alt. A includes the following sub-alternations. Note that Alts. A-1, A-2, and A-3 are cases in which the multiplexing of the first HARQ-ACK bit and the second HARQ-ACK bit is not supported. Further, Alts. A-4 and A-5 are cases in which the multiplexing of the first HARQ-ACK bit and the second HARQ-ACK bit is supported.

### Alt. A-1

In Alt. A-1, terminal 20 does not assume to transmit the second HARQ-ACK bit in a slot of a retransmission PUCCH resource for a retransmission CORESET.

### Alt. A-2

In Alt. A-2, when the second HARQ-ACK bit is not present in a slot of a retransmission PUCCH resource for a retransmission CORESET, terminal 20 does not assume that the second HARQ-ACK bit is transmitted in the same slot as the retransmission PUCCH resource for a non-retransmission CORESET.

### Alt. A-3

In Alt. A-3, when the second HARQ-ACK bit is not present in a slot of a retransmission PUCCH resource for a retransmission CORESET, terminal 20 does not assume that the second HARQ-ACK bit is transmitted on a resource overlapping with the retransmission PUCCH resource for a non-retransmission CORESET.

### Alt. A-4

In Alt. A-4, when the second HARQ-ACK CB to be transmitted in a slot of a retransmission PUCCH resource is present for a retransmission CORESET, terminal 20 adds the second HARQ-ACK bit to the first HARQ-ACK bit.

### Alt. A-5

In Alt. A-5, when the second HARQ-ACK CB to be transmitted in a slot of a retransmission PUCCH resource is not present for a retransmission CORESET, and the second HARQ-ACK CB to be transmitted in the same slot as the retransmission PUCCH resource is present for a non-retransmission CORESET, terminal 20 adds the second HARQ-ACK bit to the first HARQ-ACK bit.

### Alternation B

Alt. B is a case in which Separate feedback is configured and the above-described Option 2-2 of Proposal 2 is applied, that is, HARQ-ACK CBs are retransmitted by one-shot DCI for both the first CORESET and second CORESET.

Alt. B includes the following sub-alternations. Note that Alts. B-1 and B-2 are cases in which the multiplexing of the first HARQ-ACK bit and the second HARQ-ACK bit is not supported. Further, Alt. B-3 is a case in which the multiplexing of the first HARQ-ACK bit and the second HARQ-ACK bit is supported.

### Alt. B-1

In Alt. B-1, terminal 20 does not assume to transmit the second HARQ-ACK bit in a slot of a retransmission PUCCH resource although one-shot DCI belongs to any CORESET.

### Alt. B-2

In Alt. B-2, terminal 20 does not assume to transmit the second HARQ-ACK bit in a slot of a retransmission PUCCH resource for the CORESET to which one-shot DCI does not belong.

### Alt. B-3

In Alt. B-3, terminal 20 adds the second HARQ-ACK bit to the first HARQ-ACK bit for either the first CORESET or the second CORESET.

Note that, in Alt. B-3, which CORESET to be configured as the CORESET for which the second HARQ-ACK bit is added to the first HARQ-ACK bit may be defined by the specifications, indicated to terminal 20 by higher layer signaling such as RRC, or determined by coresetPoolIndex of one-shot DCI.

### Alternation C

Alt. C is a case in which Joint feedback is configured and the above-described Option 1 or 2-1 of Proposal 2 is applied, that is, a HARQ-ACK CB is retransmitted by one-shot DCI for either the first CORESET or second CORESET.

Alt. C includes the following sub-alternations. Note that Alts. C-1 and C-2 are cases in which the multiplexing of the first HARQ-ACK bit and the second HARQ-ACK bit is not supported. Further, Alt. C-3 is a case in which the multiplexing of the first HARQ-ACK bit and the second HARQ-ACK bit is supported.

### Alt. C-1

In Alt. C-2, terminal 20 does not assume to transmit the second HARQ-ACK bit in a slot of a retransmission PUCCH resource for the CORESET to which one-shot DCI belongs.

### Alt. C-2

In Alt. C-2, terminal 20 does not assume that the second HARQ-ACK bit is transmitted in the same slot as a retransmission PUCCH resource for the CORESET to which one-shot DCI does not belong.

### Alt. C-3

In Alt. C-3, terminal 20 adds the second HARQ-ACK bit to the first HARQ-ACK bit when the second HARQ-ACK CB to be transmitted in a slot of a retransmission PUCCH resource is present for the CORESET to which one-shot DCI belongs.

### Alternation D

Alt. D is a case in which Joint feedback is configured and the above-described Option 2-2 of Proposal 2 is applied, that is, HARQ-ACK CBs are retransmitted by one-shot DCI for both the first CORESET and second CORESET.

Alt. D includes the following sub-alternations Note that Alts. D-1 and D-2 are cases in which the multiplexing of the first HARQ-ACK bit and the second HARQ-ACK bit is not supported. Further, Alt. D-3 is a case in which the multiplexing of the first HARQ-ACK bit and the second HARQ-ACK bit is supported.

### Alt. D-1

In Alt. D-1, terminal 20 does not assume to transmit the second HARQ-ACK bit in a slot of a retransmission PUCCH resource although one-shot DCI belongs to any CORESET.

### Alt. D-2

In Alt. D-2, terminal 20 does not assume to transmit the second HARQ-ACK bit in a slot of a retransmission PUCCH resource for the CORESET to which one-shot DCI does not belong.

### Alt. D-3

In Alt. D-3, terminal 20 adds the second HARQ-ACK bit to the first HARQ-ACK bit for either the first CORESET or second CORESET.

Note that, in Alt. D-3, which CORESET to be configured as the CORESET for which the second HARQ-ACK bit is added to the first HARQ-ACK bit may be defined by the specifications, indicated to terminal 20 by higher layer signaling such as RRC, or determined by coresetPoolIndex of one-shot DCI.

### Variation

Variations for Alternations of Proposal 3 are described below.

### Variation 1

In the case that the multiplexing of the first HARQ-ACK bit and the second HARQ-ACK bit is not supported (Alts. A-1, A-2, B-1, B-2, C-1, C-2, D-1, and D-2), terminal 20 may drop the second HARQ-ACK bit.

### Variation 2

In the case that the multiplexing of the first HARQ-ACK bit and the second HARQ-ACK bit is supported (Alts. A-4, A-5, B-3, C-3, and D-3), terminal 20 may perform multiplexing by adding the first HARQ-ACK bit after the second HARQ-ACK bit, or may perform multiplexing by adding the second HARQ-ACK bit after the first HARQ-ACK bit.

### Variation 3

Supporting/not supporting of the multiplexing of the first HARQ-ACK bit and the second HARQ-ACK bit may be switched depending on the Type of retransmission HARQ-ACK CB. For example, the multiplexing of the first HARQ-ACK bit and the second HARQ-ACK bit need not be supported when the type of retransmission HARQ-ACK CB is Type 1/2, and the multiplexing of the first HARQ-ACK bit and the second HARQ-ACK bit may be supported when the type of retransmission HARQ-ACK CB is (e)Type 3.

### Variation 4

Performing/not performing of the multiplexing of the first HARQ-ACK bit and the second HARQ-ACK bit may be switched depending on the overlap of the first HARQ-ACK bit and the second HARQ-ACK bit. For example, the multiplexing of the first HARQ-ACK bit and the second HARQ-ACK bit need not be performed when some or all of the second HARQ-ACK bits overlap with the first HARQ-ACK bits, and the multiplexing of the first HARQ-ACK bit and the second HARQ-ACK bit may be performed when any of the second HARQ-ACK bits does not overlap with the first HARQ-ACK bits.

### Effects Common to all Proposals

Adopting any of the above-described Proposals or Options (or Alternations (Alts.)) of the Proposals allows for appropriate retransmission of a HARQ-ACK CB in consideration of the relation with one-shot HARQ-ACK retransmission in multi-TRP.

In each of the proposals described above, which option (or alternation (Alt.)) among the options (or alternations) of each proposal is to be used may be specified by a specification or may be configured by a parameter of a higher layer. In addition, the terminal may report by using capability information of the terminal (e.g., “UE capability”) which option (or alternation) among the options (or alternations) of each proposal is to be used. Further, which option (or alternation) among the options (or alternations) of each proposal is to be used may be determined by a combination of the configuration of the parameter of the higher layer and the reported capability information of the terminal. For example, a base station may determine one or more options (or alternations) among options (or alternations) that can be used by the terminal indicated by the reported capability information of the terminal, and the determined information may be configured by the parameter of the higher layer. Note that it is not limited to the case of being configured by the parameter of the higher layer, and the information may be indicated by control information (e.g., DCI) of a physical layer.

The capability information of terminal (UE capability) may include, for example, information defining whether the terminal supports enabling of one-shot HARQ-ACK retransmission (FG 25-7) and enabling of multi-DCI based multi-TRP (FG 16-2a) at the same time, and information defining whether the terminal supports enabling of one-shot HARQ-ACK retransmission (FG 25-7) and enabling of join/separate HARQ-ACK feedback of multi-DCI based multi-TRP (FG 16-2a-4 or FG 16-2a-4a) at the same time. In addition, the capability information of the terminal may include information indicating whether the terminal supports the above-described proposals and whether the terminal supports the options (or alternations) of the proposals, which are described above.

Note that, in the present embodiment, the term “slot” may be replaced with “sub-slot.” In addition, in the above-described embodiment, the term “slot” is a term indicating a certain time period and may be replaced with another expression. For example, the term “slot” may be replaced with another expression such as “symbol,” “time period,” or “time resource.”

Further, in the present embodiment, the term “CORESET” may be replaced with “serving cell.” In this case, the first serving cell is a serving cell in which no coresetPoolIndex is provided or coresetPoolIndex with value 0 is provided to one or more first CORESETs. Further, the second serving cell is a serving cell in which coresetPoolIndex with value 1 is provided to one or more second CORESETs.

Further, in the present embodiment, the expressions of deferral and postponing may be replaced with each other. Furthermore, the expressions, deferral and postponing, may each be replaced with another expression such as delay or procrastination.

In addition, the expressions of “limitation” and “restriction” may be replaced with each other in the present embodiment. In addition, “limitation” and “restriction” may be replaced with another expression such as “constraint,” “limit,” or “restraint.”

### <Example of Radio Communication System>

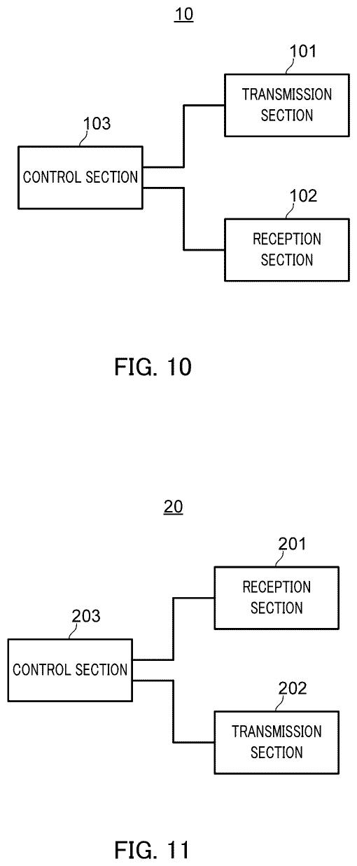

A radio communication system according to the present embodiment includes base station 10 illustrated in FIG. 10 and terminal 20 illustrated in FIG. 11. The number of base stations 10 and the number of terminals 20 are not particularly limited. Two base stations 10 and a single terminal 20 may communicate with each other in the system. The radio communication system may be a radio communication system conforming to New Radio (NR). By way of example, the radio communication system may be a radio communication system conforming to a scheme called URLLC and/or Industrial Internet of Things (IIoT).

Note that the radio communication system may be a radio communication system conforming to a scheme called 5G, Beyond 5G, 5G Evolution, or 6G.

Base station 10 may be referred to as an NG-RAN node, ng-eNB, eNodeB (eNB), or gNodeB (gNB). Terminal 20 may be referred to as user equipment (UE). In addition, base station 10 may be considered to be an apparatus included in a network to which terminal 20 connects.

The radio communication system may include a next generation-radio access network (NG-RAN). The NG-RAN includes a plurality of NG-RAN nodes, specifically, gNBs (or ng-eNBs), and connects to a core network conforming to 5G (5GC, not illustrated). Note that NG-RAN and 5GC may be simply expressed as a “network.”

Base station 10 performs radio communication with terminal 20. For example, the radio communication to be performed conforms to NR. At least one of base station 10 and terminal 20 may support massive multiple-input multiple-output (MIMO) for generating a beam (BM) with higher directivity by controlling radio signals transmitted from a plurality of antenna elements. At least one of base station 10 and terminal 20 may support carrier aggregation (CA) using a plurality of component carriers (CCs) aggregated together. Further, at least one of base station 10 and terminal 20 may support dual connectivity (DC) for performing communication between terminal 20 and each of a plurality of base stations 10.

The radio communication system may support a plurality of frequency bands. For example, the radio communication system supports frequency range (FR) 1 and FR2. The frequency band of each FR is as follows, for example.
FR1: 410 MHz to 7.125 GHz
FR2: 24.25 GHz to 52.6 GHz

FR1 may use sub-carrier spacing (SCS) of 15 kHz, 30 kHz, or 60 kHz, and may use a bandwidth (BW) of 5 MHz to 100 MHz. FR2 uses, for example, frequency higher than FR1. FR2 may use the SCS of 60 kHz or 120 kHz, and may use a bandwidth (BW) of 50 MHz to 400 MHz. In addition, the SCS of 240 kHz may also be included in FR2.

The radio communication system according to the present embodiment may further support a frequency band higher than that of FR2. For example, the radio communication system according to the present embodiment may support a frequency band up to 114.25GHz exceeding 52.6 GHz. Such high frequency band may be referred to as “FR2x.”

Further, Cyclic Prefix-Orthogonal Frequency Division Multiplexing (CP-OFDM)/Discrete Fourier Transform-Spread-Orthogonal Frequency Division Multiplexing (DFT-S-OFDM), which have the sub-carrier spacing (SCS) larger than the above examples, may be applied. The DFT-S-OFDM may be applied to both uplink and downlink, or may be applied to either one of them.

In the radio communication system, a slot configuration pattern of time division duplex (TDD) may be configured. For example, the slot configuration pattern may specify a pattern indicating the order of two or more of a slot where a downlink (DL) signal is transmitted, a slot where an uplink (UL) signal is transmitted, a slot where a DL signal, a UL signal, and a guard symbol are mixed, and a slot where a signal to be transmitted is flexibly changed.

Further, in the radio communication system, it is possible to perform PUSCH (Physical Uplink Shared Channel) (or Physical Uplink Control Channel (PUCCH)) channel estimation by using a demodulation reference signal (DMRS) per slot, and it is further allowed to perform PUSCH (or PUCCH) channel estimation by using DMRSs respectively assigned to a plurality of slots. Such channel estimation may be referred to as joint channel estimation, cross-slot channel estimation, or another name.

Terminal 20 may transmit DMRSs respectively assigned to a plurality of slots in the plurality of slots so that base station 10 can perform the joint channel estimation using the DMRSs.

Further, the radio communication system may include an additional enhanced function of feedback from terminal 20 to base station 10. The additional function includes, for example, an enhanced function of terminal feedback to HARQ-ACK.

Next, a description will be given of configurations of base station 10 and terminal 20. Note that the configurations of base station 10 and terminal 20 exemplify functions related to the present embodiment. Base station 10 and terminal 20 may have a function that is not illustrated. Note that the names of function categories and/or function sections are not limited as long as the function is for implementing an operation according to the present embodiment.

### <Configuration of Base Station>

FIG. 10 is a block diagram illustrating an exemplary configuration of base station 10 according to the present embodiment. Base station 10 includes, for example, transmission section 101, reception section 102, and control section 103. Base station 10 communicates with terminal 20 (see FIG. 11) by radio.

Transmission section 101 transmits a downlink (DL) signal to terminal 20. For example, transmission section 101 transmits the DL signal under the control of control section 103.

For example, the DL signal may include a downlink data signal and control information (e.g., downlink control information (DCI)). The DL signal may also include information indicating scheduling related to signal transmission by terminal 20 (e.g., UL grant). Further, the DL signal may include higher layer control information (e.g., control information of radio resource control (RRC)). Furthermore, the DL signal may include a reference signal.

A channel used for transmitting the DL signal includes, for example, a data channel and a control channel. For example, the data channel includes a physical downlink shared channel (PDSCH), and the control channel includes a physical downlink control channel (PDCCH). Base station 10 transmits, to terminal 20, the control information using the PDCCH, and the downlink data signal using the PDSCH, for example.

The reference signal included in the DL signal may include at least one of a demodulation reference signal (DMRS), a phase tracking reference signal (PTRS), a channel state information-reference signal (CSI-RS), a sounding reference signal (SRS), and a positioning reference signal (PRS) for position information, for example. The reference signal such as the DMRS and PTRS is used for demodulation of the downlink data signal, and transmitted using the PDSCH, for example.

Reception section 102 receives an uplink (UL) signal transmitted from terminal 20. For example, reception section 102 receives the UL signal under the control of control section 103.

Control section 103 controls a communication operation of base station 10 including transmission processing in transmission section 101 and reception processing in reception section 102.

For example, control section 103 acquires information such as data and control information from a higher layer, and outputs the information to transmission section 101. Control section 103 also outputs data, control information, and the like received from reception section 102 to the higher layer.

For example, control section 103 performs allocation of a resource (or channel) to be used for transmitting and receiving a DL signal and/or a resource to be used for transmitting and receiving a UL signal, based on data, control information, etc. obtained from a signal received from terminal 20 (e.g., data and control information) and/or a higher layer. Information on the allocated resource may be included in the control information to be transmitted to terminal 20.

Control section 103 configures a PUCCH resource, as an example of the resource to be used for transmitting and receiving a UL signal. Information on a configuration of a PUCCH such as a PUCCH cell timing pattern (PUCCH configuration information) may be indicated to terminal 20 by RRC.

Control section 103 generates one-shot DCI specifying a PUCCH resource for HARQ-ACK CB retransmission.

The above configuration allows base station 10 to appropriately perform HARQ-ACK CB retransmission in multi-TRP in consideration of the relation with one-shot HARQ-ACK retransmission.

### <Configuration of Terminal>

FIG. 11 is a block diagram illustrating an exemplary configuration of terminal 20 according to the present embodiment. Terminal 20 includes, for example, reception section 201, transmission section 202, and control section 203. Terminal 20 communicates with base station 10 by radio, for example.

Reception section 201 receives a DL signal transmitted from base station 10. For example, reception section 201 receives the DL signal under the control of control section 203.

Transmission section 202 transmits a UL signal to base station 10. For example, transmission section 202 transmits the UL signal under the control of control section 203.

The UL signal may include, for example, an uplink data signal and control information (e.g., UCI). The UL signal may include information on the processing capability of terminal 20 (e.g., UE capability), for example. The UL signal may also include a reference signal.

A channel used for transmitting the UL signal includes, for example, a data channel and a control channel. For example, the data channel includes a PUSCH and the control channel includes a PUCCH. Terminal 20 receives control information using the PUCCH from base station 10, and transmits the uplink data signal using the PUSCH, for example.

The reference signal included in the UL signal may include at least one of a DMRS, a PTRS, a CSI-RS, an SRS, and a PRS, for example. The reference signal such as the DMRS and PTRS is used for demodulation of the uplink data signal, and transmitted using an uplink channel (e.g., PUSCH), for example.

Control section 203 controls a communication operation of terminal 20 including reception processing in reception section 201 and transmission processing in transmission section 202.

For example, control section 203 acquires information such as data and control information from a higher layer, and outputs the information to transmission section 202. Control section 203 also outputs, for example, data, control information, and the like received from reception section 201 to the higher layer.

For example, control section 203 controls transmission of information to be fed back to base station 10. The information to be fed back to base station 10 may include, for example, HARQ-ACK, channel state information (CSI), or scheduling request (SR). The information to be fed back to base station 10 may be included in UCI. The UCI is transmitted using a resource of the PUCCH.

Control section 203 configures a PUCCH resource based on the configuration information received from base station 10 (e.g., configuration information such as a PUCCH cell timing pattern indicated by RRC and/or DCI). Control section 203 determines a PUCCH resource to be used for transmitting the information to be fed back to base station 10. Transmission section 202 transmits, under the control of control section 203, the information to be fed back to base station 10 using the PUCCH resource determined by control section 203.

Note that a channel used for DL signal transmission and a channel used for UL signal transmission are not limited to the examples described above. For example, the channel used for DL signal transmission and the channel used for UL signal transmission may include a random access channel (RACH) and a physical broadcast channel (PBCH). The RACH may be used for transmitting downlink control information (DCI) including a random access radio network temporary identifier (RA-RNTI).

Control section 203 controls retransmission of HARQ-ACK CB in relation to the resource specified by one-shot DCI.

The above configuration allows terminal 20 to appropriately perform HARQ-ACK CB retransmission in multi-TRP in consideration of the relation with one-shot HARQ-ACK retransmission.

The present disclosure has been described, thus far.

<Hardware Configuration and the like>

Note that, the block diagrams used to describe the above embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (e.g., via wires or wirelessly), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmission section,” “transmitting unit,” or “transmitter.” The methods for implementing the functions are not limited specifically as described above.

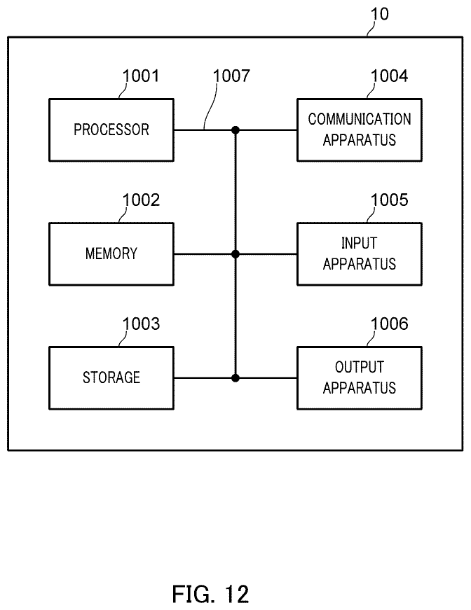

For example, a base station, a terminal, and the like according to an embodiment of the present disclosure may function as a computer that executes processing of a wireless communication method of the present disclosure. FIG. 12 illustrates an exemplary hardware configuration of the base station and the terminal according to the present embodiment. Physically, base station 10 and terminal 20 as described above may be a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of base station 10 and of terminal 20 may include one apparatus or a plurality of apparatuses illustrated in the drawings or may not include part of the apparatuses.

The functions of base station 10 and terminal 20 are implemented by predetermined software (program) loaded into hardware, such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 103 and control section 203 and the like as described above may be implemented using processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control section 203 of terminal 20 may be implemented using a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to an embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (e.g., a compact disc, a digital versatile disc, or a Blu-ray (registered trademark) disc), a smart card, a flash memory (e.g., a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and wireless networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission section 101, reception section 102, reception section 201, transmission section 202, and the like as described above may be implemented using communication apparatus 1004.

Input apparatus 1005 is an input device (for example, a keyboard, a mouse, a microphone, a switch, a button, or a sensor) that receives input from the outside. Output apparatus 1006 is an output device (e.g., a display, a speaker, or an LED lamp) that makes outputs to the outside. Note that input apparatus 1005 and output apparatus 1006 may be integrated (e.g., a touch panel).

The apparatuses, such as processor 1001, memory 1002, and the like are connected by bus 1007 for communication of information. Bus 1007 may be configured using a single bus or using buses different between each pair of the apparatuses.

Furthermore, base station 10 and terminal 20 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

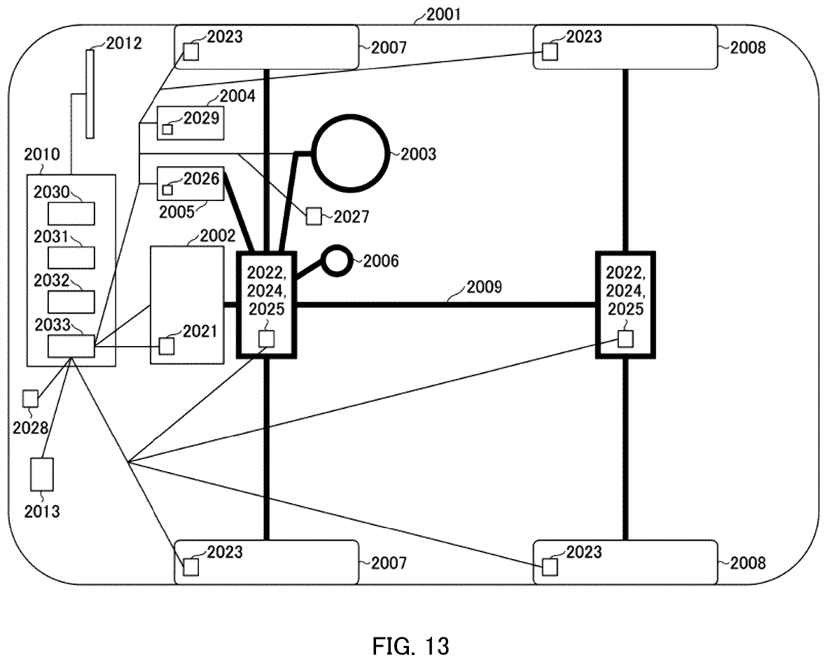

FIG. 13 illustrates an exemplary configuration of vehicle 2001. As illustrated in FIG. 13, vehicle 2001 includes drive section 2002, steering section 2003, accelerator pedal 2004, brake pedal 2005, shift lever 2006, front wheels 2007, rear wheels 2008, axle 2009, electronic control section 2010, various sensors 2021 to 2029, information service section 2012, and communication module 2013. Each aspect/embodiment described in the present disclosure may be applied to a communication device mounted in vehicle 2001, and may be applied to, for example, communication module 2013.

Drive section 2002 is composed of, for example, an engine, a motor, or a hybrid of an engine and a motor. Steering section 2003 includes at least a steering wheel (also referred to as a handle) and is configured to steer at least one of front wheels and rear wheels based on an operation of the steering wheel operated by a user.

Electronic control section 2010 includes microprocessor 2031, memory (ROM and/or RAM) 2032, and communication port (IO port) 2033. Signals from various sensors 2021 to 2029 provided in vehicle 2001 are inputted to electronic control section 2010. Electronic control section 2010 may be referred to as an Electronic Control Unit (ECU).

Signals from various sensor 2021 to 2029 includes a current signal from current sensor 2021 sensing the current of the motor, revolutions per minute (RPM) signals of the front and rear wheels acquired by RPM sensors 2022, air-pressure signals of the front and rear wheels acquired by air-pressure sensors 2023, vehicle speed signals acquired by vehicle speed sensors 2024, acceleration signals acquired by acceleration sensors 2025, a signal of the amount of pressure on an accelerator pedal acquired by accelerator pedal sensor 2026, a signal of the amount of pressure on a brake pedal acquired by brake pedal sensor 2029, a shift lever operation signal acquired by shift lever sensor 2027, and a detection signal for detecting obstacles, vehicles, pedestrians acquired by object detection sensor 2028.

Information service section 2012 is composed of various devices such as a car navigation system, an audio system, a speaker, a television, and a radio for providing (outputting) various types of information such as driving information, traffic information, entertainment information, and the like, and one or more ECUs for controlling these devices. Information service section 2012 provides various types of multimedia information and multimedia services to an occupant of vehicle 2001 using information acquired from an external apparatus via communication module 2013 or the like.

Information service section 2012 may include an input device (e.g., keyboard, mouse, microphone, switch, button, sensor, touch panel, or the like) that receives an input from the outside, or may include an output device (e.g., display, speaker, LED lamp, touch panel, or the like) that performs output to the outside.

Driving assistance system section 2030 is composed of various devices that are configured to provide functions for preventing an accident or reducing driving loads of drivers, such as a millimeter-wave radar, Light Detection and Ranging (LiDAR), a camera, a positioning locator (e.g., GNSS), map information (e.g., high-definition (HD) map, automated driving vehicle (AV) map, etc.), a gyrosystem (e.g., Inertial Measurement Unit (IMU), Inertial Navigation System (INS), etc.), an Artificial Intelligence (AI) chip, and an AI processor, and one or more ECUs for controlling these devices. Driver assistance system section 2030 transmits and receives various types of information via communication module 2013, and realizes a driving support function or an autonomous driving function.

Communication module 2013 can communicate with microprocessor 2031 and the components of vehicle 2001 via a communication port. For example, communication module 2013 transmits and receives data to and from drive section 2002, steering section 2003, accelerator pedal 2004, brake pedal 2005, shift lever 2006, front wheels 2007, rear wheels 2008, axle 2009, microprocessor 2031 and memory (ROM and/or RAM) 2032 in electronic control section 2010, and sensors 2021 to 2029 provided in vehicle 2001 via communication port 2033.

Communication module 2013 is a communication device that can be controlled by microprocessor 2031 of electronic control section 2010 and can communicate with an external apparatus. For example, various types of information are transmitted and received to and from the external apparatus via radio communication. Communication module 2013 may be either inside or outside electronic control section 2010. The external apparatus may be, for example, a base station, a mobile station, or the like.

Communication module 2013 may transmit at least one of signals from the above-described various sensors 2021 to 2029 inputted to electronic control section 2010, information acquired based on the signals, and/or information based on an input from the outside (user) acquired via information service section 2012, to the external apparatus via radio communication. Electronic control section 2010, various sensors 2021 to 2029, information service section 2012, and the like may be referred to as input sections that receives an input. For example, a PUSCH transmitted by communication module 2013 may include information based on the input.

Communication module 2013 receives various types of information (traffic information, signal information, inter-vehicle information, etc.) transmitted from the external apparatus, and displays the information on information service section 2012 provided in vehicle 2001. Information service section 2012 may be referred to as an output section that outputs information (e.g., outputs information to devices such as a display and speaker based on a PDSCH (or data/information decoded from the PDSCH) received by communication module 2013). Further, communication module 2013 stores the various types of information received from the external apparatus in memory 2032 accessible by microprocessor 2031. Based on the information stored in memory 2032, microprocessor 2031 may perform control of drive section 2002, steering section 2003, accelerator pedal 2004, brake pedal 2005, shift lever 2006, front wheels 2007, rear wheels 2008, axle 2009, sensors 2021 to 2029, and the like provided in vehicle 2001.

### <Notification of Information and Signaling>

The notification of information is not limited to the embodiments described in the present disclosure, and the information may be notified by another method. For example, the notification of information may be performed out by one or a combination of physical layer signaling (for example, Downlink Control Information (DCI) and Uplink Control Information (UCI)), upper layer signaling (for example, Radio Resource Control (RRC) signaling, Medium Access Control (MAC) signaling, notification information (Master Information Block (MIB), and System Information Block (SIB))), and other signals. The RRC signaling may be called an RRC message and may be, for example, an RRC connection setup message, an RRC connection reconfiguration message, or the like.

### <Application System>

The embodiments described in the present specification may be applied to at least one of systems using Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

<Processing Procedure and the like>

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

### <Operation of Base Station>

Specific operations which are described in the present disclosure as being performed by the base station may sometimes be performed by an upper node depending on the situation. Various operations performed for communication with a user terminal in a network constituted by one network node or a plurality of network nodes including a base station can be obviously performed by at least one of the base station and a network node other than the base station (examples include, but not limited to, MME or S-GW). Although there is one network node in addition to the base station in the case illustrated above, a plurality of other network nodes may be combined (for example, MME and S-GW).

### <Direction of Input and Output>

The information and the like (see “Information and Signals”) can be output from a higher layer (or a lower layer) to a lower layer (or a higher layer). The information, the signals, and the like may be input and output through a plurality of network nodes.

<Handling of Input and Output Information and the like>

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

### <Determination Method>

The determination may be made based on a value expressed by one bit (0 or 1), based on a Boolean value (true or false), or based on comparison with a numerical value (for example, comparison with a predetermined value).

<Variations and the like of Aspects>

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### <Software>

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

### <Information and Signals>

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### <System and Network>

The terms “system” and “network” used in the present disclosure can be interchangeably used.

### <Names of Parameters and Channels>

The information, the parameters, and the like described in the present disclosure may be expressed using absolute values, using values relative to predetermined values, or using other corresponding information. For example, radio resources may be indicated by indices. The names used for the parameters are not limitative in any respect. Furthermore,

the numerical formulas and the like using the parameters may be different from the ones explicitly disclosed in the present disclosure. Various channels (for example, PUCCH and PDCCH) and information elements, can be identified by any suitable names, and various names assigned to these various channels and information elements are not limitative in any respect.

### <Base Station>

The terms “Base Station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” and “component carrier” may be used interchangeably in the present disclosure. The base station may be called a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

### <Mobile Station>

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

### <Base Station/Mobile Station>

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the terminal. For example, the embodiments of the present disclosure may find application in a configuration that results from replacing communication between the base station and the terminal with communication between multiple terminals (such communication may, for example, be referred to as device-to-device (D2D), vehicle-to-everything (V2X), or the like). In this case, terminal 20 may be configured to have the functions that base station 10 described above has. The wordings “uplink” and “downlink” may be replaced with a corresponding wording for inter-equipment communication (for example, “side”). For example, an uplink channel, a downlink channel, and the like may be replaced with a side channel.

Similarly, the terminal in the present disclosure may be replaced with the base station. In this case, base station 10 is configured to have the functions that terminal 20 described above has.

### <Meaning and Interpretation of Terms>

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### <Reference Signal>

The reference signal can also be abbreviated as an RS and may also be called as a pilot depending on the applied standard.

<Meaning of “Based on”>

The description “based on” used in the present disclosure does not mean “based only on,” unless otherwise specified. In other words, the description “based on” means both of “based only on” and “based at least on.”

### <“First” and “Second”>

Any reference to elements by using the terms “first,” “second,” and the like used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### <Means>

The “means” in the configuration of each apparatus may be replaced with “section,” “circuit,” “device,” or the like.

### <Open Form>

In a case where terms “include,” “including,” and their modifications are used in the present disclosure, these terms are intended to be inclusive like the term “comprising.”Further, the term “or” used in the present disclosure is not intended to be an exclusive “or.”

<Time Unit such as TTI, Frequency Unit such as RB, and Radio Frame Configuration>

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are used in each user terminal) on the basis of TTI to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

### <Maximum Transmit Power>

“The maximum transmit power” described in the present disclosure may mean a maximum value of the transmit power, the nominal UE maximum transmit power, or the rated UE maximum transmit power.

### <Article>

In a case where articles, such as “a,” “an,” and “the” in English, for example, are added in the present disclosure by translation, nouns following these articles may have the same meaning as used in the plural.

### <“Different”

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

<“/”>

In the present disclosure, the symbol “/” may mean “or.” For example, the phrase “A/B” may be interpreted as “A or B.”

### INDUSTRIAL APPLICABILITY

An aspect of the present disclosure is useful for radio communication systems.

### REFERENCE SIGNS LIST

10 Base station
20 Terminal
101, 202 Transmission section
102, 201 Reception section
103, 203 Control section

1.-5. (canceled)

6. A terminal comprising:
a receiving section that receives downlink control information that triggers retransmission of an acknowledgement codebook in a specific control resource set; and
a control section that controls the retransmission of the acknowledgement codebook,
wherein, when the acknowledgement feedback mode is set to separate, the control section determines the acknowledgement codebook to be retransmitted based on the control resource set in which the downlink control information was detected.

7. The terminal according to claim 6, wherein
when the downlink control information is detected in a first control resource set, the control section retransmits the acknowledgment codebook in a slot in the first control resource set which is after specific slots from the slot in which the downlink control information was received, and
when the downlink control information is detected in a second control resource set, the control section retransmits the acknowledgment codebook in a slot in the second control resource set which is after specific slots from the slot in which the downlink control information was received.

8. The terminal according to claim 6, wherein
when a second acknowledgement codebook exists in a slot to retransmit the acknowledgement codebook, the control section appends the second acknowledgement codebook to the acknowledgement codebook.

9. A base station comprising:
a transmitting section that transmits downlink control information that triggers retransmission of an acknowledgement codebook in a specific control resource set; and
a receiving section that receives the acknowledgment codebook retransmitted based on the downlink control information;
wherein, when the acknowledgement codebook to be retransmitted is determined based on the control resource set in which the downlink control codebook was detected.

10. A system comprising:
a base station that transmits downlink control information that triggers retransmission of an acknowledgement codebook in a specific control resource set;
a terminal that receives the downlink control information and controls the retransmission of the acknowledgment codebook;
wherein, when the acknowledgement feedback mode is set to separate, the terminal determines the acknowledgement codebook to be retransmitted based on the control resource set in which the downlink control information was detected.
